(19) United States
(12) Patent Application Publication
(10) Pub. No.: US 2014/0090862 A1
(43) Pub. Date: Apr. 3, 2014

(54) HANDHELD POWER TOOL HAVING A DRIVE MOTOR EMBODIED TO PROVIDE A PREDETERMINED MAXIMUM MOTOR POWER LEVEL

(71) Applicants: Hansjoerg Beutel, Pfullingen (DE); Andreas Friese, Pfalzgrafenweiler (DE); Joachim Heizmann, Immendingen (DE); Marco Braun, Stuttgart-Feuerbach (DE); Hamed Feridouni, Stuttgart (DE); Andreas Kynast, Sttutgart (DE); Dietmar Saur, Gomaringen (DE); Patrick Budaker, Heubach (DE)

(72) Inventors: Hansjoerg Beutel, Pfullingen (DE); Andreas Friese, Pfalzgrafenweiler (DE); Joachim Heizmann, Immendingen (DE); Marco Braun, Stuttgart-Feuerbach (DE); Hamed Feridouni, Stuttgart (DE); Andreas Kynast, Sttutgart (DE); Dietmar Saur, Gomaringen (DE); Patrick Budaker, Heubach (DE)

(73) Assignee: Robert Bosch GmbH, Stuttgart (DE)

(21) Appl. No.: 14/037,567

(22) Filed: Sep. 26, 2013

(30) Foreign Application Priority Data
Oct. 1, 2012 (DE) 10 2012 217 906.2

(51) Int. Cl. B25B 21/00; B25F 5/02

(52) U.S. Cl. CPC B25B 21/00; B25F 5/02
USPC 173/217

(57) ABSTRACT

A handheld power tool includes a drive motor embodied to provide a predetermined maximum motor power level, the handheld power tool having an associated power tool volume, and the maximum motor power level and the power tool volume forming a power-to-volume ratio of at least 270 W/l.

### CROSS REFERENCE TO RELATED APPLICATION

The present application claims priority to Application No. DE 10 2012 217 906.2, filed in the Federal Republic of Germany on Oct. 1, 2012, the contents of which are incorporated herein in its entirety by reference thereto.

### FIELD OF INVENTION

The present invention relates to a handheld power tool having a drive motor embodied to provide a predetermined maximum motor power level, the handheld power tool having an associated power tool volume.

### BACKGROUND INFORMATION

The existing art discloses a handheld power tool of this kind that can be embodied, for example, as a screwdriver, in particular as a drywall screwdriver or impact screwdriver. This has a drive motor, embodied as a commutator motor, that has suitable brushes associated with it for commutation and is embodied to provide a predetermined maximum motor power level. The drive motor, equipped with brushes, is disposed in a power tool housing that, with a tool receptacle associated with the screwdriver, embodies a corresponding power tool volume.

The existing art is disadvantageous in that because of the predetermined maximum motor power level, a screwdriver of this kind can transfer to an associated inserted tool, during operation, only a limited power output that, for example in the case of so-called “10.8 V” (or 12 V) electrical power tools, is less than 240 W. This power output can moreover be provided only in the context of a sufficiently large power tool volume of approximately 0.5 l to 1.3 l, with the result that a desirable decrease in the size of the handheld power tool is impeded, and its areas of application and usability are thus limited.

### SUMMARY

An object of the present invention is therefore to provide a novel handheld power tool that makes it possible, even when a corresponding power tool housing is made smaller, to provide a power output that is sufficient for usability in different areas of application and instances.

This problem is solved by a handheld power tool having a drive motor embodied to provide a predetermined maximum motor power level, the handheld power tool having an associated power tool volume. The maximum motor power level and the power tool volume form a power-to-volume ratio of at least 270 W/l.

The present invention thus makes it possible to provide a handheld power tool in which, independently of a respective power tool volume, it is possible to provide a power output that is sufficient for usability of the handheld power tool in different areas of application. Handheld power tools having a comparatively small power tool volume and a comparatively high power output can thus be provided.

The power tool volume is preferably defined in a range from 0.5 l to 1.3 l.

Even conventional handheld power tools can thus be embodied to provide a power output sufficient for usability of the handheld power tool in different areas of application.

According to an exemplary embodiment, the drive motor is an electronically commutated electric motor.

The present invention thus enables the use of drive motors of comparatively small dimensions in order to generate comparatively high motor power levels and power outputs.

Preferably, a plurality of rechargeable-battery cells is supplied in order to provide an operating voltage in the range from 8 V to 14.4 V for operation of the drive motor. According to an exemplary embodiment, three rechargeable-battery cells connected in series constitute the plurality of rechargeable-battery cells for providing an operating voltage of at least 10.8 V.

It is thus possible to provide handheld power tools of a predetermined tool type, and in particular so-called “10.8 V” (or 12 V) electrical power tools, which are characterized by a corresponding rated voltage of a rechargeable-battery pack constituted in each case by a plurality of rechargeable-battery cells, having an increased power output and decreased power tool volume. This enables a user to perform larger-scale tasks than would be possible with a 10.8 V (or 12 V) electrical power tool known from the existing art, i.e., for example to screw comparatively larger screws into wood, or to screw in comparatively more screws for each charge of the rechargeable-battery pack.

The plurality of rechargeable-battery cells is preferably disposed in a power tool housing that constitutes the associated power tool volume. The power tool housing preferably constitutes a handle in which the plurality of rechargeable-battery cells is disposed.

Disposition of the rechargeable-battery cells in the power tool housing or in the handle makes it possible to achieve a decrease in the power tool volume in simple fashion, thereby making it possible to provide a handheld power tool that is smaller as compared with the existing art. The result is to enable improved workplace configuration in particular in industrial applications thanks to an ergonomic power tool shape, so that special tools such as, for example, right-angle drivers, etc., are unnecessary.

According to an exemplary embodiment, the drive motor has an outside diameter of at most 38 mm. The drive motor preferably constitutes an external element that has an outside diameter of at most 38 mm.

The present invention thus makes it possible to provide a drive motor of comparatively small dimensions that is suitable for providing a comparatively high motor power level.

According to an exemplary embodiment, the handheld power tool is embodied as a screwdriver, in particular as a drywall screwdriver or impact screwdriver.

The present invention can thus be utilized with handheld power tools in which comparatively high motor power levels with a comparatively small power tool volume are desirable.

Exemplary embodiments of the present invention are described in further detail below with reference to the accompanying drawings.

### BRIEF DESCRIPTION OF THE DRAWINGS

FIG. 1 is a schematic view of a handheld power tool having an inserted tool according to an exemplary embodiment of the present invention.

### DETAILED DESCRIPTION

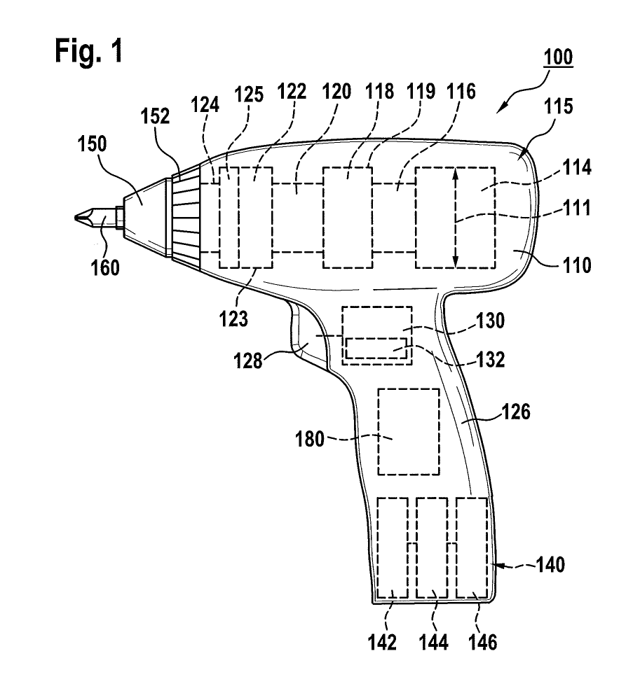

FIG. 1 shows a handheld power tool 100 that is equipped with a tool receptacle 150 for receiving an inserted tool 160 and has a power tool housing 110 having a handle 126. Power tool housing 110 is embodied, by way of example, in a T-shape, and constitutes an associated power tool volume 115. Expressed more specifically, power tool housing 110 and tool receptacle 150 disposed thereon enclose a volume that is referred to in the context of the present invention as “power tool volume” 115 and is defined, for example, within a range from 0.5 l to 1.3 l.

Disposed illustratively in power tool housing 110 are a drive motor 114 embodied to provide a predetermined maximum motor power level, a gearbox 118, and an optional impact mechanism 122. Drive motor 114 is, for example, a brushless or electronically commutated electric motor that preferably is electronically controllable in open- or closed-loop fashion such that both a reverse mode and stipulations in terms of a desired rotation speed can be implemented. According to an exemplary embodiment, drive motor 114 is embodied such that the maximum motor power level that it can provide during operation of handheld power tool 100, and power tool volume 115, form a power to volume ratio of at least 270 W/l. This can be enabled in particular by the above-described use of an electronically commutated electric motor as a drive motor.

Drive motor 114 is embodied, by way of example, using an “open frame” design, and is thus disposed directly in power tool housing 110 without an associated motor housing. In contrast thereto, gearbox 118 illustratively has a gearbox housing 119 that is disposed in power tool housing 110. By way of example, a model PG6 three-stage planetary gearbox of Robert Bosch GmbH (item no. 2609199605) can be used to implement gearbox 118. However, other gearboxes can also be used, gearbox 118 can also, for example, be disposed directly in power tool housing 110, or drive motor 114 can have a motor housing and can thus be implemented using a “can” design.

In the present exemplary embodiment, drive motor 114 constitutes, merely illustratively, an outer element having an outside diameter 111. According to an exemplary embodiment, this outside diameter is equal to at most 38 mm; in addition, for example, positioning and/or alignment projections that are, for example, each 2 mm long can additionally be supplied on the outer element in order to simplify positioning and alignment, respectively, of drive motor 114 upon installation into power tool housing 110.

A model BL 38 electronically commutated open frame motor of Robert Bosch GmbH (item no. 160702264A) can be used, for example, as a drive motor having an outside diameter of 38 mm. However, other drive motors can also be used, and the mode of operation and construction of a suitable drive motor are sufficiently known from the existing art and will therefore not be further described here in the interest of a concise description.

According to an exemplary embodiment, drive motor 114 can be actuated, i.e., can be switched on and off, with a manual switch 128 connected to an on/off switch 130; on/off switch 130, embodied preferably with galvanic isolation, has, e.g., a potentiometer 132 that, upon an actuation of manual switch 128 during operation of handheld power tool 100, serves as a signaling element for establishing a particular motor power level to be provided by drive motor 114. On/off switch 130 can moreover be connected to a rotation direction switch with which a respectively desired rotation direction of inserted tool 160 is definable in order to enable a reverse mode of drive motor 114.

Illustratively, drive motor 114 is connected via an associated motor shaft 116 to gearbox 118, which converts a rotation of motor shaft 116 into a rotation of a drive member 120, e.g., an input drive shaft, supplied between gearbox 118 and the optional impact mechanism 122. This conversion preferably occurs such that on the basis of a respective motor power level generated by drive motor 114, input drive shaft 120 rotates relative to motor shaft 116 with increased torque but at a decreased rotation speed. An optional fan wheel can be disposed, for example, on motor shaft 116, which wheel is embodied to generate in power tool housing 110 a cooling air flow that can remove, by convection, heat that occurs during operation of handheld power tool 100, for example due to motor and/or gearbox power dissipation in power tool housing 110.

The optional impact mechanism 122 connected to input drive shaft 120 is, for example, a rotary or rotational impact mechanism, equipped with an impact member 125, that generates high-intensity rotary impact pulses and transfers them via impact member 125 to an output drive shaft 124, e.g., an output drive spindle. Impact mechanism 122 is disposed illustratively in an associated impact mechanism housing 123, but alternatively thereto can also be disposed in another suitable housing, e.g., in gearbox housing 119 or in power tool housing 110.

The optional impact mechanism 122 is preferably embodied as a mechanical impact mechanism for impact driving of output drive shaft 124, in which mechanism the impact member 125 is disposed, for example, longitudinally displaceably and at least partly rotationally movably on input drive shaft 120, and is spring-loaded there toward output drive shaft 124. An example of a mechanical impact mechanism with which impact mechanism 122 can be realized is described in German Application No. DE 20 2006 014 850, to which reference is expressly made here and whose contents are incorporated herein its entirety by reference thereto, so that for the sake of a concise description a detailed description of impact mechanism 122 can be omitted here.

Tool receptacle 150, embodied to receive an inserted tool 160, e.g., a screwdriver bit, is supplied by way of example on output drive shaft 124. This receptacle is embodied illustratively as a clamping chuck equipped with a clamping sleeve 152, and is therefore also referred to hereinafter as “clamping chuck 150.” According to an exemplary embodiment, a permanent connection is embodied between this clamping chuck 150 and output drive shaft 124 in order to prevent at least tool-free detachment of clamping chuck 150 from output drive shaft 124.

In the context of the present invention the term “permanent” means that no provision is made for removal of clamping chuck 150 from handheld power tool 100 by a user, and clamping chuck 150 is thus an integral constituent of handheld power tool 100. Replacement of clamping chuck 150 can in principle be possible, for example in order to avoid acquisition of an entirely new handheld power tool following damage, but at least not in tool-free fashion and preferably not without opening tool housing 110. In other words, in the context of the present invention the term “permanent” therefore means that clamping chuck 150 is the principal tool receptacle of handheld power tool 100 and is not connected to handheld power tool 100 in the form of a detachable or exchangeable adapter or tool attachment.

However, the description of a use of clamping chuck 150 permanently connected to output drive shaft 124 is merely exemplary in nature, and is not to be understood as limiting of the present invention. Instead, a so-called “bit holder” or another other tool receptacle, including one already known to one skilled in the art, which can also be connected detachably or replaceably to output drive shaft 124, can also be utilized.

According to an exemplary embodiment, handheld power tool 100 has a plurality of rechargeable-battery cells 140 for supplying power in grid-independent fashion to drive motor 114. These are supplied, for example, in order to provide an operating voltage in the range from 8 V to 14.4 V for operation of drive motor 114, and are preferably embodied to provide an operating voltage of at least 10.8 V. By way of example, the plurality of rechargeable-battery cells 140 has for this purpose three rechargeable-battery cells 142, 144, 146 connected in series. These can constitute a so-called “exchangeable” battery and can be implemented, e.g., with lithium ion cells to provide an operating voltage of 10.8 V, and in the interest of installation space optimization are illustratively disposed in power tool housing 110, and in particular in handle 126. An OXI model rechargeable-battery pack (i.e., a so-called “OXI pack”) of Robert Bosch GmbH (item no. 2607336879) can be used, for example, to implement the three rechargeable-battery cells 142, 144, 146 connected in series.

Also disposed illustratively in handle 126 is an electronic control unit 180. The latter serves at least to apply control to and commutate drive motor 114 in a suitable manner that is also, for example, familiar to one skilled in the art.

According to an exemplary embodiment, handheld power tool 100 is embodied as a rechargeable battery-powered impact driver. However, the present invention is not limited to rechargeable battery-powered impact drivers, but instead can be utilized in general in the context of screwdrivers, in particular impact screwdrivers and/or drywall screwdrivers, and moreover generally in the context of different handheld power tools in which a power to volume ratio of at least 270 W/l can be enabled, e.g., in an impact drill, etc., regardless of whether the handheld power tool is operable electrically, i.e., in grid-independent fashion with the plurality of rechargeable-battery cells 140 or in corded fashion, and/or non-electrically.

What is claimed is:

1. A handheld power tool, comprising:
a drive motor embodied to provide a predetermined maximum motor power level, the handheld power tool having an associated power tool volume, wherein the maximum motor power level and the power tool volume form a power-to-volume ratio of at least 270 W/l.

2. The handheld power tool according to claim 1, wherein the power tool volume is defined in a range from 0.5 l to 1.3 l.

3. The handheld power tool according to claim 1, wherein the drive motor is an electronically commutated electric motor.

4. The handheld power tool according to claim 1, wherein a plurality of rechargeable-battery cells is supplied in order to provide an operating voltage in a range from 8 V to 14.4 V for operation of the drive motor.

5. The handheld power tool according to claim 4, wherein three rechargeable-battery cells connected in series constitute the plurality of rechargeable-battery cells for providing an operating voltage of at least 10.8 V.

6. The handheld power tool according to claim 4, wherein the plurality of rechargeable-battery cells is disposed in a power tool housing that constitutes the associated power tool volume.

7. The handheld power tool according to claim 6, wherein the power tool housing constitutes a handle in which the plurality of rechargeable-battery cells is disposed.

8. The handheld power tool according to claim 1, wherein the drive motor has an outside diameter of at most 38 mm.

9. The handheld power tool according to claim 8, wherein the drive motor constitutes an external element that has an outside diameter of at most 38 mm.

10. The handheld power tool according to claim 1, wherein the power tool is embodied as a screwdriver, a drywall screwdriver or an impact screwdriver.
